(19) United States
(12) Patent Application Publication
(10) Pub. No.: US 2015/0040625 A1
(43) Pub. Date: Feb. 12, 2015

(54) COMPOSTING APPLIANCE

(71) Applicant: The Procter & Gamble Company, Cincinnati, OH (US)

(72) Inventors: Jennifer Melissa Ross DEVINE, Cincinnati, OH (US); Russell Lance SPEILLER, Montgomery, OH (US); Arthur Hampton NEERGAARD, Cincinnati, OH (US)

(21) Appl. No.: 14/522,613

(22) Filed: Oct. 24, 2014

Related U.S. Application Data
(63) Continuation of application No. PCT/US2013/038093, filed on Apr. 25, 2013.
(60) Provisional application No. 61/638,515, filed on Apr. 26, 2012.
(60) Provisional application No. 61/644,587, filed on May 9, 2012.

(51) Int. Cl. C05F 17/02; C05F 17/00

(52) U.S. Cl. CPC C05F 17/0282; C05F 17/0072; C05F 17/0045; C05F 17/0205; C05F 17/0294
USPC 71/8; 435/287.1; 435/286.1

(57) ABSTRACT

Composting Appliances are useful in reducing waste.

### FIELD OF THE INVENTION

The present invention is related to a composting appliance useful for composting waste.

### BACKGROUND OF THE INVENTION

In-home composting appliances have been described. See e.g., US 2008/0209967 A1; JP 3601973 B2. Composting within a home provides convenience. Food scraps are simply placed in the appliance (versus discarded in the trash). The benefits of composting include the reduction of waste in landfills and an economical source of plant food.

There are several problems associated with composting appliances in the market today. Composting typically has an initial reaction phase and a subsequent curing phase. These phases are typically not synchronous such that one of the phases becomes rate limiting thereby interrupting the ability of the user to have continuous composting. There is a need to have these phases substantially synchronous so the user can have virtually uninterrupted composting of their foods scraps etc. To achieve phase synchronicity of composting there is a need to monitor and achieve optimizing conditions for each of the phases.

### SUMMARY OF THE INVENTION

The present inventions attempt to address one or more of these needs. The present invention addresses these problems in what represents a paradigm shift in composting appliance design. Current systems typically will move the compostable material to conditions (e.g., transferring to another container) verses the present invention which keeps the compost contained in single container throughout the course of the composting phase(s) to bring conditions to the compost or compostable material. These conditions typically will include inter alia heat, moisture, agitation and the like.

In one aspect of the invention, a composting appliance is provided. The appliance comprises a container capable of containing compostable materials. An odor sensor is configured to sense malodor emitted from the container.

In a second aspect of the invention, a method of composting is provided. One step of the method includes providing a home composter, wherein the composter comprises (i) at least a first container capable of containing compostable materials; (ii) an odor sensor configured to sense malodor emitted from the first container; (iii) a perfume dispenser capable of dispensing a perfume composition, wherein the odor sensor and the perfume dispenser are configured to be in electrical communication; and (iv) a vial containing the perfume composition, wherein the vial is configured such that the perfume dispenser is in fluid communication with the perfume composition contained in the vial. Additional steps of the method include containing compostable materials in the first container, and composting the compostable materials contained in the first container. The method also includes the steps of emitting malodor in airspace from the compostable materials contained in the first container; sensing malodor emitted from the first container in the airspace using the odor sensor; and dispensing the perfume composition contained in the vial in response to the sensed malodor emitted from the first container.

A third aspect of the invention provides a method of composting comprising the steps: providing a container configured to receiving compostable materials; containing compostable materials in the container; composting the compostable materials contained in the container; emitting malodor from the container containing the compostable materials; providing an odor detector in fluid communication with the container; and sensing the emitted malodor with the odor detector.

A fourth aspect of the invention provides for a composting appliance comprising: at least a first container capable of containing compostable materials; a first moisture sensor configured to sense water content of either the compostable materials contained in the first container or airspace contained in the first container; and a hydrating dispenser configured to dispense an aqueous composition into the first container, wherein in the first moisture sensor and hydrating dispenser are in electrical communication.

A fifth aspect of the invention provides for a method of composting comprising the steps: containing compostable material in a first container; heating the compostable materials contained in the first container; sensing water content of either: the compostable materials contained in the first container; or airspace contained in the first container; hydrating the compostable material contained in the first container based on the sensed water content of either said materials contained in the first container; or said airspace contained in the first container; and composting the compostable materials contained in the first container to compost.

A sixth aspect of the invention provides for a method of a kit comprising a composting appliance, wherein the appliances comprises: at least a first container capable of containing compostable materials; a first moisture sensor configured to sense water content of either: the compostable materials contained in the first container, or airspace contained in the first container; and a hydrating dispenser configured to dispense an aqueous composition into the first container, wherein in the first moisture sensor and hydrating dispenser are in electrical communication. The kit also comprises an aqueous composition container containing the aqueous composition, wherein the hydrating dispenser is fluid communication with the aqueous composition contained the aqueous composting container.

A seventh aspect of the invention provides a composting appliance, wherein the appliance comprises: at least a first container capable of containing compostable materials; and a hydrating dispenser configured to dispense an aqueous composition into the first container. A kit is also provided that includes the aforementioned appliance and an aqueous composition container containing the aqueous composition, wherein the hydrating dispenser is fluid communication with the aqueous composition contained the aqueous composting container.

An eighth aspect of the invention provides for a composting appliance comprising a composting appliance, wherein the appliance comprises: at least a first container capable of containing compostable materials; a first temperature sensor configured to sense the temperature of either the first container or the compostable materials contained in the first container; a heating element in thermal communication with the first container configured to heat the first container to multiple temperature points; and a programmable controller in electrical communication with the temperature sensor and the heating element, wherein the programmable controller is programmed to heat the container to at first temperature point and the second temperature point.

A ninth aspect of the invention provides for a method of composting comprising the steps: containing compostable material in a first container; heating the compostable materials contained in the first container to a first temperature; heating the compostable materials contained in the first container to a second temperature; and composting the compostable material contained in the first container to compost.

A tenth aspect of the invention provides for a kit wherein the kit comprises a composting appliance and a unit dose article. The appliance comprises at least a first container capable of containing compostable materials; a first temperature sensor configured to sense the temperature of either: the first container; or the compostable materials contained in the first container; a heating element in thermal communication with the first container configured to heat the first container to multiple temperature points; and a programmable controller in electrical communication with the temperature sensor and the heating element, wherein the programmable controller is programmed to heat the container to the first temperature point and the second temperature point. The unit dose article comprises a composting bacterium configured to be dosed into the composting appliance.

An eleventh aspect of the invention provides for a composting appliance comprising at least a first container capable of containing compostable materials; and a first aerobic sensor configured to sense aerobic or anaerobic conditions of the compostable materials contained in the first container.

A twelfth aspect of the invention provides for a composting appliance comprising: at least a first container capable of containing compostable materials; and an aerator device configured to aerate either the compostable materials contained in the first container; or the airspace above the compostable materials contained in the first container.

A thirteenth aspect of the invention provides for a method of composting, where the method comprises the steps: containing compostable material in a first container; heating the compostable material in the first container; mixing the compostable material in the second container; aerating either the compostable materials contained in the first container or airspace above the compostable materials container in the first container.

A fourteenth aspect of the invention provides for a method of composting, wherein the method comprises the steps: containing compostable material in a first container; heating the compostable material in the first container; sensing aerobic or anaerobic conditions of the compostable materials contained in the first container; mixing the compostable materials in the first container in response to said sensed aerobic or anaerobic condition; composting the compostable material contained in the first container to compost.

A fifteenth aspect of the invention provides for a method of continuous composting comprising the steps of curing in a first container and reacting in a second container, wherein the compostable materials are added to the reacting second container at least twice per day for 14 consecutive days.

A sixteenth aspect of the invention provides for a home composting appliance comprising: (a) a housing defining an air outlet port; (b) a container housed within the housing and configured to contain compostable materials; (c) a mixing element housed in the container, wherein the mixing element is configured to mix the compostable materials contained in the container; (d) a motor coupled to the mixing element and configured to rotate the mixing element; (e) a heater housed n the housing and configured to heat the container; (f) one or more sensors housed within the housing; and (g) a programmable controller for automatically controlling at least the motor and the heater, and in electrical communication with one or more of the sensors; and (h)an optional air filter in fluid communication with the air outlet port configured to filter air in the housing prior to the air exiting the housing.

### DETAILED DESCRIPTION OF THE INVENTION

### Dual Containers

One aspect of the invention provides for at least two containers, preferably wherein the two containers are side-by-side containers. In one embodiment, the side-by-side containers are not in fluid communication with each other (i.e., compostable materials cannot be transferred between the containers while the respective containers are functionally located inside the composting appliance).

The containers are capable of containing compostable materials and conducting composting as to turn compostable materials into compost, soil amendment, or the like. There may be several advantages to such a design. For example, a heating element may be placed in-between the two containers (to emit heat into the contents of the containers) to provide more efficient use of heat emitted from heating elements—potentially from a manufacturing and/or energy consumption perspectives. In stackable configuration, heat may not be evenly distributed to both vessels.

In one embodiment, a container is releasably attached to the body of the appliance. For example, the container may be attached by a rotational mechanism such that a rotational turn of the container by a user around a perpendicular axis removes the container from the body of the appliance. Another example would be a snap-in-place mechanism with a lever release system for securing the container inside of the body of the appliance. Alternatively, both containers are releasably attached to the body of the appliance. The releasable attaching feature of the container provides convenient filling of the container or more preferably dispensing of finished compost. The user is simply able to carry the container to a desired location (e.g., flower bed) and tip over the container to release the compost from the container—all without soiling the user's hands. This is sharp contrast to some composting appliance designs which requires the user to physically scoop or remove finished compost from the container that is fixed (i.e., not removable) from the body of the appliance.

Another aspect of the composting process provides that the composting phases are substantially the same duration by inter alia optimizing the reaction conditions for each of the respective phases. This provides the benefit to the user of essentially always having a container available to dose compostable materials. In some two-container composting appliances the curing phase takes much longer than the reaction phase (or vice versa) so that the phases do not temporally align. In these appliances, the user can be placed in a situation where the user must wait for the curing phase to complete before starting a new cycle of composting. In the present invention, the phases take about the same time to complete such that the user can rotate the curing and reaction phases between the two containers. In other words, a first container of the present invention may be undergoing a curing phase (thereby not allowing the addition of compostable materials from the user) and a second container may be undergoing a reaction phase there by allowing the user to add compostable materials. The present invention also contemplates the use of a plurality of phases (2, 3, 4 or more phases) and a plurality of containers (2, 3, 4 or more containers in single composting appliance).

Although the preferred design of the present invention represents a dual compartment design, the present invention also contemplates the use of a pre-grinder where compostable materials are grinded into smaller pieces for more efficient composting. The pre-grinder can be standalone, integral to the appliance, or part of a system (e.g., wherein the appliance is mounted under a kitchen sink and a “garbage disposal” is used as the pre-grinder). The pre-grinder, in one embodiment, is a high speed blender-type mixing element. In yet another embodiment, “grinding element(s)” are found integral to the mixing element integral to the dual containers of the appliance.

In one embodiment, the container comprises one or more “fill-lines” located on the inside surface of the container to indicate to the user how much more compostable material may be deposited into the container of the composting appliance. The fill-line can take the form of the line or partial line (or the like) that protrudes and/or recesses from the inside surface of the container. Alternatively or additionally, color may be used to indicate the fill-line or make the fill-line more prominent to the user and thus easily readable (particularly when the color of the fill-line is in contrast to the background color of the inside surface of the container). Alternatively or additionally, an optical sensor (preferably in electrical communication with the PC) may be used to assess the fill level of the contents contained in the container. The optical sensor may be integral or non-integral to the container.

Each container may be configured to contain from about 1 liter to about 100 liters, alternatively from 25 liters to 75 liters, alternatively from 35 liters to 65 liters, alternatively combinations thereof.

At least a portion of the container may be thermally insulated to maximize the temperature conditions to the contents contained within the container. Insulating materials are well known.

The use of a bag, preferably biodegradable plastic bags, may line the inside surface of the container as to facilitate the removal of composted materials from the composting appliance. A suitable manufacture of bags may be sold under the brand name GLAD. Alternatively, the appliance may contain a mechanism to deposit the contents of the container into a bag.

### Double Lid Design

One aspect of the invention provides at least two lids to cover each of the respective openings of the containers of the composting appliance. Another aspect of the invention provides a mechanism to restrict a user to open only one lid of the multiple lids of the appliance so that compostable materials can only be dosed into the active phase container (vs. the curing phase) container.

In one embodiment, there is an inner lid and an outer lid. The inner lid could be slidable or flipable to expose only one of the two containers. The inner lid is in closer proximity to the opening of the container as compared to the outer lid. An outer lid would cover (from the external environment) the inner lid (and both containers).

In another embodiment, two lids would be in the same plane, preferably sharing a single hinge; however, such an embodiment would have a mechanism that only allows the user to open one lid at a time (i.e., not both lids). In an embodiment, the appliance could comprise an indicium to visibly and/or auditory indicate to the user which container the user may deposit compostable materials into at any given time. The indicium, for example, may be found on an external surface of the appliance including a lid. A visual indicium may include, for example, a green light (vs. a red light or no light) on the lid covering the container undergoing active phase composting (and thus suitable for dispensing additional compostable material there into) so only the appropriate container is to be accessed by the user at a given time. A second indicium may be used to indicate when one of the container has completed the composting process (i.e., such the compostable materials are converted to compost) and so the contents of the container are ready to be removed by the user and thereafter the container is ready to begin the composting process once again. The use of one or more indicium solves the problem of the user knowing which container is undergoing the active phase and/or when the composting process is completed.

### Heating Elements

One aspect of the invention provides for at least one heating element configured inbetween the two containers. In another aspect of the invention, a heating element is placed below one or more of the containers. Each of the containers may be heated to the same of different temperatures (at any given point in time). The heating elements could be adjusted to maximize the active/curing phases of the respective containers. In one embodiment, a first container is undergoing an active curing phase; whereas the second container is undergoing a curing phase. A thermosensor (e.g., thermometer) could be used to help adjust the desired temperature of the container (thereby maximizing the respective processing conditions contained therein). Ideally the curing and active phases are substantially synchronistic. The container may be comprised of metal, plastic, or combination thereof.

Mixing Elements with optional Wall Scrapers

One aspect of the invention provides for a mixing element configured to mix contents (i.e., compostable materials) contained in one or more of the containers of the composting appliance. The mixing element is motor driven. In one embodiment, the mixing element may be releasably affixed in the interior of the container. The user, by being able to remove at least a portion of the mixing element, is able to more conveniently empty the contents contained in the container and/or clean the interior of the container and/or clean the mixing element. In another embodiment, the mixing element may further comprise a “wall scraper” as to maximize the mixing of the compost contained in the container. Without wishing to be bound by theory, many mixing elements of home composters contain a mixing element that does not adequately remove compost that often adheres to the wall of the container thereby exhibiting inefficiencies in the home composting process. One aspect of the invention provides a mixing element that comprises a wall scraper. In one embodiment, the mixing element is rotary wherein the axis of rotation is perpendicular to the base of the composting appliance (i.e., perpendicular from a level floor or countertop). In another embodiment, the wall scraper may comprise a rubber, polymeric, or other flexible material that makes contact with the wall of the container but does not scratch or damage the interior wall of the container as the wall scraper makes functional contact with the interior wall. In yet another embodiment, the wall scraper of the mixing element need not make contact with the interior wall for the entire 360 degree rotation. Rather, the wall scraper may make contact with the wall one, two, three or more times during a 360 rotation. Alternatively, the wall scraper makes continuous contact with the wall during a 360 rotation.

### Multiple Sensors for Composting Efficiency

One aspect of the invention is to provide the temporally synchronistic active and curing phases of composting process. This solves an unmet need of a composting appliance to be essentially ready any time to accept compostable materials from the user. Some commercially available machines have a lag period where the composter cannot accept compostable materials from the user given that the curing phase is much longer than the active phase. There is a further opportunity to increase the efficiency of active phase to lower the time of the curing phase (thereby shortening the overall time of the composting appliance).

In one embodiment, a temperature sensor is employed. A temperature sensor senses the temperature of the container or the temperature of the contents contained in the container. The temperature sensor can be a thermometer attached to the container. The temperature sensor can be an Infrared Sensor directed to the inside of the container to determine the temperature of the contents contained in the container. The temperature sensor is electrically coupled to a heating element to increase or decrease the heat emitted to the heating element. Alternatively the temperature sensor is electrically coupled to a Programmable Controller (PC) wherein the PC in turn is electrically coupled to the heating element. The PC may execute a program to maximize the temperature conditions of the curing/active phases (to maximize the efficiency of the process). The program will dictate what the temperature should be maintained at and for how long a specific temperature should be maintained (i.e., a time period).

In one embodiment, there are at least two temperature points (alternatively, 3, 4, 5 or more temperature points). These multiple temperature points can be optimized for the particular cycle (i.e., active or curing phase). For example, the temperature of the container is heated to and maintained at a first temperature for a first time period, thereafter the container is heated to and maintained at a second temperature for a second time period, and so on. In a non-limiting example, the container during the active phase is heated at 55° C. for 2 days, and thereafter heated at 40° C. for 5 days. In another non-limiting example, the container during the curing phases is heated at 60° C. for 1 day, and thereafter heated at 35° C. for 3 days. Of course the exact time and temperature/duration will depend upon the size of the appliance, the choice of composting enzyme and/or composting microorganisms (e.g., bacteria), and other variables known to those in the composting arts.

In one embodiment, an aerobic sensor is employed. An aerobic sensor is used to monitor the aerobic and/or anaerobic conditions of contents contained in one or more of the containers of the inventive composting appliance. Preferably the aerobic sensor is used during both the active and curing phases with the objective of keeping the conditions as aerobic (vs. anaerobic) to maximize composting conditions (or at the respective phase conditions). Aerobic sensors may include detectors to monitor O₂, CO₂, CO, NH₄, HS, or other anaerobic by-products, or combinations thereof. The aerobic sensor can be in electrical communication to a mixing and/or aerator device. Alternatively the aerobic sensor can be in electrical communication to a PC wherein the PC in turn is in electrical communication to the mixing element and/or aerator device. The mixing element may be modified by timing (i.e., frequency, duration etc) and intensity (e.g., higher or lower RPM) and direction (e.g., forward, reverse, horizontal, vertical). The aerator device may aerate (e.g., injecting, blowing, or the like) atmospheric air into the contents contained in the container or in the airspace above the contents contained in the container. In addition to or in lieu of atmospheric air, stored O₂ may also be used.

In one embodiment, there are at least two aerobic sensed points (alternatively, 3, 4, 5 or more aerobic sensed points). These multiple aerobic sensed points (or levels of aeration) can be optimized for the particular cycle (i.e., active or curing phase). For example, the aerobic/anaerobic conditions of the container is maintained at a first aerobic sensed point for a first time period, thereafter the container maintained at a second aerobic sensed point for a second time period, and so on.

In one embodiment, a moisture sensor is employed. One or more moisture sensors may be employed to assess the water content of the contents contained in the container and/or water content of the air space above the contents contained in the container. The moisture sensor can be electrically coupled to a hydrating dispenser. Alternatively the moisture sensor can be electrically coupled to a PC wherein the PC in turn is electrically coupled to the hydrating dispenser. The hydrating dispenser is configured to dispense an aqueous composition. The objective of dispensing the aqueous compositions is to increase the moisture (i.e., water) content of the compostable materials contained in the container (or water content of the air space contained in the container) with the objective of maximizing the efficiency of the composting process (or the respective phase conditions) of the composting appliance. The hydrating dispenser may dispense the aqueous compositions from a variety of sources including a refillable reservoir, from a user's home or business water line, or a replaceable aqueous composition container. The aqueous composition may comprise, in addition to water, ingredients that may complement the composting process (e.g., enzyme, prebiotic, etc) and/or reduce malodor emitting as a result of the composting process.

In one embodiment, there are at least two moisture sensed points (alternatively, 3, 4, 5 or more aerobic sensed points). These multiple moisture sensed points (or multiple moisture levels) can be optimized for the particular cycle (i.e., active or curing phase). For example, the moisture conditions of the container is maintained at a first moisture sensed point for a first time period, thereafter the container maintained at a second moisture sensed point for a second time period, and so on.

In one embodiment, an odor sensor is employed. One or more odor sensors may be employed to assess the malodor: contained in the container and/or air space contained in the container; and/or being emitted from the contents contained in the container. An example of an odor sensor may include one described by U.S. Pat. No. 6,093,308. The odor sensor can be electrically coupled to a perfume dispenser (wherein the perfume dispenser is capable of dispensing a perfume composition). Examples of perfume compositions suitable for dispensing in the present context may include those in the U.S. patent publication of co-filed P&G Case 12404P. In one embodiment, the perfume composition comprises a perfume oil composition. Alternatively the odor sensor can be electrically coupled to a PC wherein the PC in turn is electrically coupled to a perfume composition dispenser. The term “dispensing” is used herein in the broadest sense. The device is capable of dispensing the odor eliminating composition by way of simple diffusion (US 2010/0308130; US 2010/0314461), a wick system (preferably heating a wick that is in functional contact with the composition (or the composition itself)) per U.S. Pat. No. 7,223,361; vibration (e.g., ultrasonic or piezoelectric) per US 2011/0266359 A1; or combinations thereof. Alternatively, the odor sensing and perfume dispenser may be integral such as described in US 2010/0044453 A1. The perfume composition can be contained in a vial as a consumable that can be replaced by the user from time to time. The term “vial” is broadly defined to include container that are generally suitable to contain perfume composition. A non-limiting example of a vial includes a scented oil refills for FEBREZE NOTICEables (Procter & Gamble). In one embodiment, the vial contains from about 5 ml to about 250 m of a perfume composition, alternatively from 25 ml to about 125 ml, alternatively from about 50 ml to about 150 ml, alternatively combinations thereof.

In one embodiment, a methane sensor is employed. Methane (sometimes referred to as a swamp gas) may result from the composting process. At certain concentrations, methane can be dangerous given its flammability. One or more methane sensor may be employed. An example of a methane sensor may include those described in U.S. Pat. No. 5,767,388; and US 2011/0248857 A1. The methane sensor can be in electrical communication to a mixing element and/or aerator device. Alternatively or in addition, the methane sensor can be in electrical communication to an alarm (wherein the alarm is auditory, visual, or combination thereof) and/or employ a safety shut-off. Upon sensing a pre-determined level of methane, the sensor may initiate the alarm and/or mixing element and/or aerator device. Alternatively, the methane sensor can be in electrical communication to a PC wherein the PC in turn is in electrical communication to the previously discussed components (e.g., mixing element, aerator device, alarm, safety shut-off) and is capable of initiating one or more of these components.

A PC is utilized. A suitable PC, in one embodiment, is selected from a programmable automation controller or a programmable logic controller. A useful programmable automation controller may be selected from the Control Logic family of programmable automatic controllers from Rockwell Automation (Anaheim, Calif., USA).

### UV Light

In one aspect of the invention, the composting appliance has an ultraviolet light emitting device functionally attached to a lid or inside surface of a container as to shine UV light into the container with the objective of sterilizing, sanitizing, pasteurizing, or the like, the contents contained in the container of inventive appliance. In one embodiment, the UV light is shown at or near the conclusion of the curing phase. In another embodiment, there are safety features to prevent the user from lifting the light of the container and being exposed to UV light. These safety features may include the lid locking while the UV light is on or an automatic shut off so that UV light is turned off when the lid of the container is lifted.

### Load-Determining Device

In one aspect of the invention the composting appliance contains a load-determining device. There may also be a data acquisition unit in electrical communication with the load-determining device. The load-determining device may comprise a counting device and/or system or other measuring apparatus or system for determining a quantifiable measure (e.g., weight, quantity, etc.) of the compostable material deposited into a container or contained in the container (“deposited-material measure”). The simplest example of such a device is a scale to measure the weight of the material (i.e. kg). The scale may be in electrical communication with the PC. Alternatively the load-determining device may be in electrical communication with a data-acquisition unit for storage and/or subsequent processing. The data acquisition unit may be stand alone or integral part of the PC. The deposited-material measure may be used to optimize compost processing conditions, provide basis for providing information to the user by way of the “Status Indicia” (discussed below), or even as part of a marketing system (see e.g., the U.S patent publication of co-filed P&G Case 12401P), or combinations thereof. The deposited-material measure may be taken anytime during the composting process including but not limited to the start, end of phase, beginning phase, conclusion of composting, or combination thereof. In one embodiment, the deposited-material measure is taken at the end of the composting process.

### Status Indicia

In one aspect of the invention, the composting appliance contains at least one status indicium that indicates the status of one or more of the containers in the composting process.

The indicium may comprise a light, timer, words, symbols, colors, combinations thereof to indicate to the user that composting status of the contents contained in one or more of the containers of the composting appliance. For example, there may be one indicium for each container. The indicium may have a timer that indicates how many hours, days, weeks, specific date, count-down timer, combination thereof, that remain for the composting process or cycle or phase thereof. The indicium may indicate which container the user should add food stuffs into (e.g., lighted green arrow) and which container the user should not add foods stuff into (lighted red “X”). The indicium may also have text that provides encouragement by highlighting the benefits of the composting (e.g., “you have saved 10 kg from going to the landfill”) or providing advice in how to maximize the composting process (e.g., “do not forget to add a composting pack of enzyme/probiotics”). Status indicium can indicate to the user when the UV light is on or off. The status indicium may also indicate to the user when one or more lids are in the closed/open position. The status indicium of the present invention is preferably electrically coupled to the PC.

### Bag

In one aspect of the invention, a system is provided where one or more containers of the appliance contains a bag, preferably a plastic bag, more preferably a biodegradable bag, alternatively a biodegradable plastic bag. Without wishing to be bound by theory, the bag provides the convenience of removing and/or transporting the compost from the appliance. In one embodiment, the bag has one or more coatings that temporarily protects the bag from the composting process—yet still allows the bag to be biodegradable. In another embodiment, the bag remains in the container and remains in place during the duration, preferably the substantial duration, of the composting process. The bag may have composting ingredients to assist in the composting appliance (e.g., composting bacteria or prebiotic, composting enzymes, etc.). Alternatively, the plastic bag is part of a system where a user is instructed to deposit the contents of compost resulting from the composting process utilizing the present appliance into a plastic bag.

The appliance of the present invention may be placed on a counter top, mounted under a counter top (analogous to a trash compactor), under a kitchen sink, on the floor as a stand along unit, or integrally with a garbage disposal.

### Air Filter

The appliance of the present invention may have one or more exhaust(s) configured to provide fluid communication between the airspace contained in the container to the atmosphere outside of the container. An optional fan may be used to create a vacuum in the exhaust. The filter may comprise activated carbon. The filter may also contain a perfume composition and/or an odor eliminating composition. See e.g., U.S. patent publication of co-filed P&G Case 12404P.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composting appliance comprising:
(a) at least a first container capable of containing compostable materials; and
(b) an odor sensor configured to sense malodor emitted from the first container.

2. The appliance of claim 1, further comprising a second container, wherein the odor sensor is configured to sense malodor emitted from the second container.

3. The appliance of claim 1, further comprising a second container and a second odor sensor, wherein the second odor sensor is configured to sense malodor emitted from the second container.

4. The appliance of claim 2, wherein the first odor sensor is in electrical communication to a perfume dispenser, wherein the perfume dispenser is configured to dispense perfume composition.

5. The appliance of claim 4, wherein the first odor sensor is in fluid communication with the first container.

6. The appliance of claim 4, wherein the first container and the second container are side-by-side, and wherein the first container and the second container are not in fluid communication with each other.

7. The appliance of claim 6, wherein the first container and the second container are each removably attached to the appliance.

8. The appliance of claim 7, wherein the first container and the second container each comprise a removably attached mixing element.

9. The appliance of claim 8, wherein the removably attached mixing elements further comprise an elastomeric component, wherein the elastomeric component is configured to make contact with a side wall of the respective first and second containers.

10. A method of composting comprising the steps:
(a) providing a home composter comprising: (i) at least a first container capable of containing compostable materials; (ii) an odor sensor configured to sense malodor emitted from the first container; (iii) a perfume dispenser capable of dispensing a perfume composition, wherein the odor sensor and the perfume dispenser are configured to be in electrical communication; and (iv) a vial containing the perfume composition, wherein the vial is configured such that the perfume dispenser is in fluid communication with the perfume composition contained in the vial;
(b) containing compostable materials in the first container;
(c) composting the compostable materials contained in the first container;
(d) emitting malodor in airspace from the compostable materials contained in the first container;
(e) sensing malodor emitted from the first container in the airspace using the odor sensor;
(f) dispensing the perfume composition contained in the vial in response to the sensed malodor emitted from the first container.

11. The method of claim 10, further comprising the steps:
(a) wherein providing the home composter further comprises a second container capable of containing compostable materials;
(b) containing compostable materials in the second container;
(c) composting the compostable materials contained in the second container;
(d) emitting malodor in the airspace from compostable materials contained in the second container;
(e) sensing a quantity of the malodor emitted from the second container in the airspace using the odor sensor;
(f) dispensing the perfume composition contained in the vial in response to the sensed quantity of malodor from the second container.

12. The method of claim 11, further comprising the steps:
(a) wherein the odor sensor comprises a first odor sensor and a second odor sensor, wherein the first odor sensor is configured to sense malodor emitted from the first container, and wherein the second odor sensor is configured to sense malodor emitted from the second container;
(b) wherein sensing the quantity of the malodor from the second container in the airspace comprises using the second odor sensor; and
(c) wherein sensing the quantity of the malodor from the first container in the airspace comprises using the first odor sensor.

13. The method of claim 10, further comprising the steps:
(a) wherein the first container is removably attached to the appliance, and removing the first container from the appliance;
(b) emptying the composted compostable materials contained in the removed container;
(c) attaching the emptied removably attached contained to the composting appliance.

14. The method of claim 12, further comprising the steps:
(a) wherein the first container is removably attached to the appliance, and removing the first container from the appliance;
(b) wherein the second container is removably attached to the appliance, and removing the second container from the appliance
(c) emptying the composted compostable materials contained in the removed first container;
(d) emptying the composted compostable materials contained in the removed second container;
(e) attaching the emptied removably attached first container to the composting appliance;
(f) attaching the emptied removably attached second contained to the composting appliance.

15. The method of claim 14, wherein the step of composting further comprises heating the compostable materials contained in the respective first container and second container.

16. The method of claim 15, wherein the step of composting further comprising mixing the compostable materials contained in the respective first container and second container.

17. A method of composting comprising the steps:
(a) providing a container configured to receiving compostable materials;
(b) containing compostable materials in the container;
(c) composting the compostable materials contained in the container;
(d) emitting malodor from the container containing the compostable materials;
(e) providing a odor detector in fluid communication with the container; and
(f) sensing the emitted malodor with the odor detector.

18. The method of claim 17, wherein composting the compostable materials contained in container further comprises heating and/or mixing said compostable materials.

19. The method of claim 18, further comprising the step of dispensing a perfume composition upon detecting the emitted malodor.

20. The method of claim 19, wherein the step of dispensing the perfume composition further comprises dispensing from a vial containing the perfume composition.
